(19) United States
(12) Patent Application Publication
(10) Pub. No.: US 2024/0320575 A1
(43) Pub. Date: Sep. 26, 2024

(54) METHOD, DEVICE, AND COMPUTER-READABLE MEDIUM FOR DISPATCHING A PLURALITY OF AGENTS TO A PLURALITY OF TASKS

(71) Applicant: Humanitas Solutions Inc., Montreal (CA)

(72) Inventors: Mehdi Asadi, Montreal (CA); Maroua Ben Attia, Laval (CA); Abdo Shabah, Montreal (CA)

(21) Appl. No.: 18/615,237

(22) Filed: Mar. 25, 2024

Related U.S. Application Data
(60) Provisional application No. 63/492,087, filed on Mar. 24, 2023.

(51) Int. Cl. G06Q 10/0631

(52) U.S. Cl. CPC G06Q 10/06311

(57) ABSTRACT

A computer-implemented method for dispatching a plurality of agents to a plurality of tasks, the method comprising: identifying, at least one agent-task pair from a plurality of possible agent-task pairs based on a primary cost function of a first assignment of agents to tasks to be used to generate a trimmed plurality of possible agent-task pairs; generating a second assignment of agents to tasks with the primary cost function that is at least as optimal as the primary cost function of the first assignment; generating a third assignment of agents with a secondary cost function that is at least as optimal as the secondary cost function of the second assignment, such that the primary cost function of the third assignment is at least as optimal as the primary cost function of the second assignment; and dispatching the plurality of agents to the plurality of tasks based on the third assignment.

### TECHNICAL FIELD

The present disclosure relates to agent assignment to tasks and, more particularly, to a method for dispatching a plurality of agents to a plurality of tasks.

### BACKGROUND

Problems of optimal agent-task assignment and partitioning of the agents into optimal clusters for a multi-agent system are highly impacted by the number of agents and the tasks to be completed by said agents.

Traditional methods for dispatching a plurality of agents to a plurality of tasks typically use heuristics and metaheuristic techniques that are less than optimal as they can only result in an approximate (sub-optimal) solutions.

Even when the traditional methods find an exact solution for only a portion of the optimization problem, the applicability of their methods is severely restricted by the limitations imposed in terms of the number of agents and tasks that their methods can handle.

There is therefore a need for new methods that solve, in an optimal manner, the distributed and opportunistic assignment of agents to tasks as well as clustering of the agents assigned to each task, independent of the number of tasks and the number of agents that will perform these tasks.

The present disclosure aims at providing an improved method for dispatching a plurality of agents to a plurality of tasks in an optimal manner.

### SUMMARY

This summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

According to a first aspect, the invention is directed to a computer-implemented method for dispatching a plurality of agents to a plurality of tasks, the method comprising: identifying, by a processor, at least one agent-task pair from a plurality of possible agent-task pairs based on a primary cost function of a first assignment of agents to tasks to be used to generate a trimmed plurality of possible agent-task pairs; generating, by the processor, a second assignment of agents to tasks with the primary cost function that is at least as optimal as the primary cost function of the first assignment of agents to tasks by performing a first search on the trimmed plurality of possible agent-task pairs; generating, by the processor, a third assignment of agents to tasks with a secondary cost function that is at least as optimal as a secondary cost function of the second assignment of agents to tasks by performing a second search on the trimmed plurality of possible agent-task pairs, such that the primary cost function of the third assignment of agents to tasks is at least as optimal as the primary cost function of the second assignment of agents to tasks; and dispatching the plurality of agents to the plurality of tasks based on the third assignment of agents to tasks.

According to a preferred embodiment, the secondary cost function represents variation of a cost among agents assigned to each task.

According to a preferred embodiment, the primary cost function of the first assignment is based on a cost of a least-optimal agent-task pair in the first assignment.

According to a preferred embodiment, the trimmed plurality of possible agent-task pairs is generated by removing agent-task pairs from the plurality of possible agent-task pairs associated with a cost less optimal than or equal to the primary cost function of the first assignment.

According to a preferred embodiment, generating the second assignment is performed by: identifying, from the trimmed plurality of possible agent-task pairs, a first replacement agent-task pair associated with a more optimal cost compared to the primary cost function of the first assignment; generating a graph representation of the plurality of possible agent-task pairs; performing a depth-first search of the graph to find an augmenting path connecting said first replacement agent-task pair; and if said augmenting path is found, generating the second assignment based on the augmenting path; otherwise, using the first assignment as the second assignment.

According to a preferred embodiment, the first replacement agent-task pair is an agent-task pair associated with a most optimal cost for the same task.

According to a preferred embodiment, the plurality of possible agent-task pairs is represented by a graph, wherein the graph comprises a first plurality of vertices each corresponding to one of the plurality of agents, a second plurality of vertices each corresponding to one of the plurality of tasks, and a plurality of edges each connecting a vertex from the first plurality of vertices to a vertex in the second plurality of vertices, wherein each edge represents a possible agent-task pair, and wherein a weight of each edge represents a cost of said agent-task pair.

According to a preferred embodiment, the second assignment optimizes the primary cost function.

According to a preferred embodiment, generating the third assignment is performed by: identifying from the second assignment a task associated with a sub-optimal secondary cost function; identifying one or more agents assigned to said task causing said task to be associated with the sub-optimal secondary cost function; identifying, from the trimmed plurality of possible agent-task pairs, one or more replacement agents that when replacing the identified one or more agents, the secondary cost function becomes more optimal; generating a graph representation of the plurality of possible agent-task pairs; performing a depth-first search of the graph to find an augmenting path connecting one of the one or more replacement agents to said task; and if said augmenting path is found, generating the third assignment based on the augmenting path; otherwise, using the second assignment as the third assignment.

According to a preferred embodiment, said task associated with the sub-optimal secondary cost function corresponds to a task associated with a least optimal secondary cost function of the second assignment.

According to a preferred embodiment, the third assignment is Pareto optimal.

According to a preferred embodiment, wherein each agent is dispatched to no more than one task at a time.

According to a preferred embodiment, each task requires to be processed by a specific number of agents and wherein at least one task is dispatched with no more than the required specific number of agents for said task.

According to a preferred embodiment, the primary cost function represents a temporal duration of processing of a task by an agent.

According to a preferred embodiment, at least one of the plurality of agents is a drone.

According to a preferred embodiment, at least one of the plurality of tasks is to neutralize a drone.

According to a preferred embodiment, the processor comprises a plurality of processors of the plurality of agents, and wherein the method is implemented in a distributed manner.

According to a second aspect, the invention is directed to a non-transitory computer-readable medium comprising computer program code stored thereon for dispatching a plurality of agents to a plurality of tasks, wherein the code, when executed by one or more processors, causes the one or more processors to perform a method comprising: identifying at least one agent-task pair from a plurality of possible agent-task pairs based on a primary cost function of a first assignment of agents to tasks to be used to generate a trimmed plurality of possible agent-task pairs; generating a second assignment of agents to tasks with the primary cost function that is at least as optimal as the primary cost function of the first assignment of agents to tasks by performing a first search on the trimmed plurality of possible agent-task pairs; generating a third assignment of agents to tasks with a secondary cost function that is at least as optimal as the secondary cost function of the second assignment of agents to tasks by performing a second search on the trimmed plurality of possible agent-task pairs, such that the primary cost function of the third assignment of agents to tasks is at least as optimal as the primary cost function of the second assignment of agents to tasks; and dispatching the plurality of agents to the plurality of tasks based on the third assignment of agents to tasks.

The method may furthermore comprise performing any of the operations described above in connection with the first aspect of the disclosure.

According to a third aspect, the invention is directed to a computing device comprising one or more processors operable to perform a method for dispatching a plurality of agents to a plurality of tasks, wherein the method comprises: identifying at least one agent-task pair from a plurality of possible agent-task pairs based on a primary cost function of a first assignment of agents to tasks to be used to generate a trimmed plurality of possible agent-task pairs; generating a second assignment of agents to tasks with the primary cost function that is at least as optimal as the primary cost function of the first assignment of agents to tasks by performing a first search on the trimmed plurality of possible agent-task pairs; generating a third assignment of agents to tasks with a secondary cost function that is at least as optimal as the secondary cost function of the second assignment of agents to tasks by performing a second search on the trimmed plurality of possible agent-task pairs, such that the primary cost function of the third assignment of agents to tasks is at least as optimal as the primary cost function of the second assignment of agents to tasks; and dispatching the plurality of agents to the plurality of tasks based on the third assignment of agents to tasks.

The one or more processors may be operable to perform any of the operations described above in connection with the first aspect of the disclosure.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Further features and exemplary advantages will become apparent from the following detailed description, taken in conjunction with the appended drawings, in which:

FIG. 1 is a logical modular representation of an exemplary system comprising a computing device for dispatching a plurality of agents to a plurality of tasks;

FIG. 2 is a flow chart of an exemplary method for dispatching a plurality of agents to a plurality of tasks;

FIG. 3 is a flow chart of an exemplary method for generating the second assignment;

FIG. 4 is a flow chart of an exemplary method for generating the third assignment; and

FIG. 5 illustrates an example of a plurality of drones dispatched to a plurality of tasks;

FIG. 6 illustrates an example graph representation of the trimmed plurality of possible agent-task pairs; and

FIGS. 7-16 illustrate an example graph representation of the trimmed plurality of possible agent-task pairs undergoing steps of the disclosed method.

### DETAILED DESCRIPTION

There is shown and described a computer-implemented method for dispatching a plurality of agents to a plurality of tasks.

### Tasks

The tasks described herein may be realized as tracking and interception of stationary or mobile physical targets, allocation of memory units, assignment of computational loads, supplying power grid demands. Each task may require one or more agents for its completion.

### Agents

The agents may take the form of vehicles, quadrotors, mobile robots, drones, Unmanned Aerial Vehicle (UAVs), Unmanned Ground Vehicle (UGVs), Central Processing Unit (CPUs), electrical power units, machines. The agents may form a plurality of transmitting mobile nodes.

In a preferred embodiment, each agent comprises a networking unit 1210, a sensing unit 1260, a storage unit 1400A, a processor unit 1230, and an action unit 1270.

### Networking Unit

The networking unit 1210 may be any network infrastructure. Examples of such a network infrastructure include Mobile Ad-hoc NETwork (MANET) that is able to provide a distributed architecture or even a centralized architecture. Other examples of such a network infrastructure may include the Heterogeneous Embedded Ad-hoc Virtual Emergency Network (HEAVEN).

### Sensing Unit

The sensing unit 1260 is primarily for discovery and mapping of the environment. Indeed, sensing unit 1260 allows the agents to obtain the main features, characteristics, and mapping of their surrounding environment as well as observe and detect potential targets and tasks as they move in the field. In some applications, the sensing unit may not be needed.

In a preferred embodiment, the agents are equipped with a cooperative and distributed implementation of the Simultaneous Localization And Mapping (SLAM) approach in order to localize the agents and the detected targets without relying on an external positioning system. This objective is achieved with the help of information exchange between agents within the networking unit 1210 such that the local information obtained by each agent is exchanged with the local information of its immediate neighboring agents.

The sensing unit 1260 may utilize any distributed version of existing distributed multi-sensing solutions such as Simultaneous Localization And Mapping (SLAM) methods with distributed outlier resilient property. As an example, the Robot Operating System (ROS) may be used to interface with the on-board camera and handle information exchange between different core units. The Buzz programming language may be employed for communication and scheduling between the agents. In the front-end of the SLAM, RTAB-Map (Real-Time Appearance-Based Mapping) may be utilized for stereo visual odometry along with VLAD (Vector of Locally Aggregated Descriptors). The visual feature extraction and relative pose transformation estimation may be performed by adapting the implementation of VLAD in RTAB-Map. The extracted features may be tracked by ORB (Oriented fast and Rotated Brief) descriptors. The data-training stage of an AI-based NetVLAD package may be implemented on You Only Look Once YOLO. The Georgia Tech Smoothing And Mapping GTSAM library may be used to implement the distributed and robust PGO (Pose Graph Optimization) unit. In addition, PCM (Pairwise Consistent Measurement) technique may be used for the outlier rejection which is tailored to a distributed setup.

As the agents and targets move in the environment, the local measurements obtained from the on-board sensors of the agents are utilized as inputs for the distributed SLAM to generate an understanding about:
the mapping of the surrounding environment as well as identifying the mobile and stationary obstacles in the immediate proximity of each agent;
the trajectory traveled by each agent which may be used in the path-planning process of the agent;
the relative position and velocity of the neighboring agents with respect to each agent;
a global understanding about the relative position and velocity vectors of all targets with respect to each agent; and
a local understanding about the relative position and velocity vectors of the target with respect to each agent.

As the agents move along and new local measurements are obtained by their on-board sensors, the outputs of the distributed SLAM procedure may be used to identify new tasks to be fed back into the method 200 for dispatching a plurality of agents to a plurality of tasks. This loop may continue until at least a threshold number of tasks is executed by the agents, signifying the successful termination of said tasks. In some instances, this loop is continued until no new task is identified and all tasks are terminated.

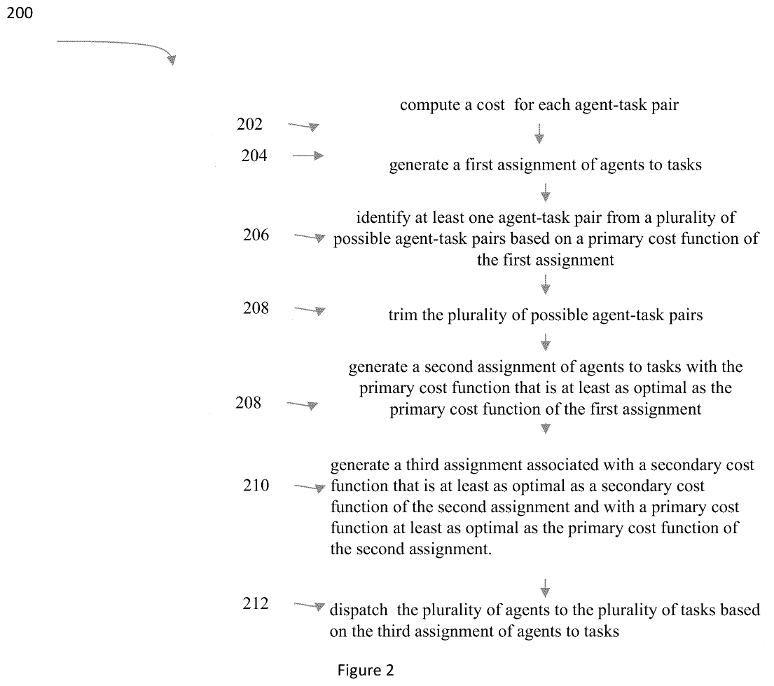

The processor unit 1230 allows for implementation of the computer-implemented method 200 for dispatching a plurality of agents to a plurality of tasks shown in FIG. 2.

The processor unit 1230 may be set to generate the exact optimal assignment in real-time through distributed implementation of the method 200 without the need for any centralized authority.

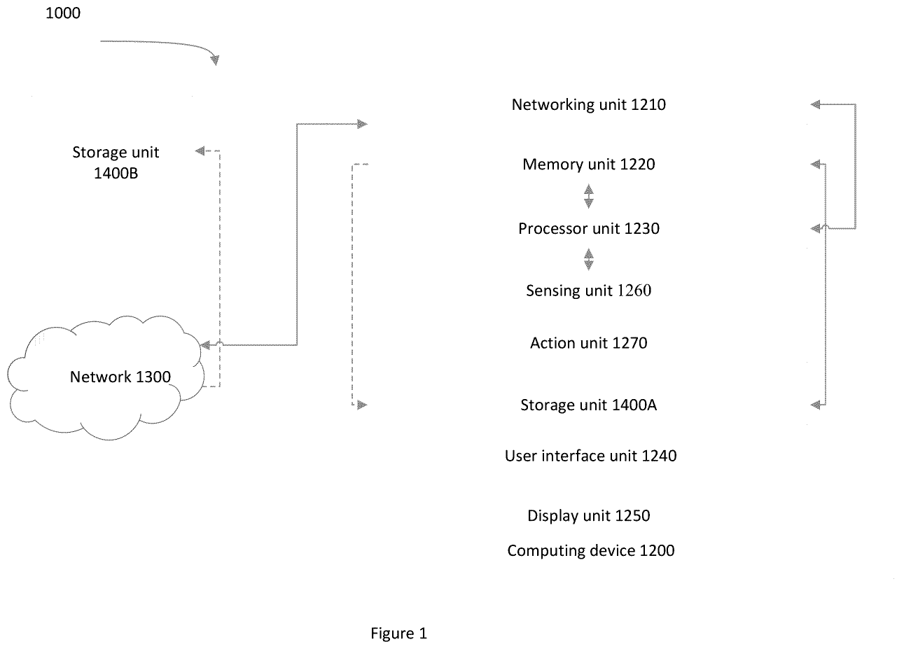

FIG. 1 shows a logical modular representation of an exemplary system 1000 in accordance with the teachings herein. The system 1000 comprises a computing device 1200 for dispatching a plurality of agents to a plurality of tasks. The computing device 1200 thus configured comprises a memory unit 1220, a processor unit 1230, a user interface unit 1240, a network interface unit 1210, and a storage unit 1400A. The storage unit 1400A may be a standard hard disk drive, a solid state drive, a tape drive, RAID storage, or any form of non-volatile memory that meets the various requirements for storing and retrieving data. A storage unit 1400B may be externally connected to the computing device 1200. The storage unit 1400B may be a remote network storage connected to the server 1200 via the network 1300. Alternatively, or in addition, the storage unit 1400A may be integrated with the computing device 1200. The computing device 1200 may further comprise a display device 1250, which may be a remote display device connected to the computing device 1200 through the network 1300 (not shown), a display device directly connected to the computing device 1200 (not shown), or an integrated display device 1250. The network interface unit 1210 is for sending and receiving data through the network 1300 to and from the plurality of agents.

The system 1000 further comprises a network 1300 for connecting each agent to the surrounding agents. Communication over the network 1300 may occur using for example, TCP/IP and Ethernet or ATM SONET/SDNET; over air, copper wires, optical fiber, or any other physical support capable of carrying data. In the preferred embodiment, the network 1300 is the Internet. The computing device 1200 may be connected to the network 1300 in a variety of ways, such as via a wired network, via a cellular network, via Wi-Fi, or via Bluetooth. A skilled person will understand that the computing device 1200 may comprise multiple computing devices 1200 in a cluster or other similar shared-processing or distributed-processing architectures, whether in a single location or over cloud computing.

Reference is now made concurrently to FIG. 1 and FIG. 2, with respect to an exemplary method 200 for dispatching a plurality of agents to a plurality of tasks. Method 200 may optionally start by generating 204 a first assignment of agents to tasks. An agent is said to be assigned to a task when the agent is elected to execute the task. The first assignment may be generated without any specific optimization. For example, the first assignment may be generated in a random manner.

In some implementations, a first assignment may already be available to be used by method 200. In this case, method 200 may use the available first assignment.

In all cases, once the first assignment is available, method 200 goes on to identify 206, by a processor 1230, at least one agent-task pair from a plurality of possible agent-task pairs based on a primary cost function of the first assignment. Then, the plurality of possible agent-task pairs is trimmed 208 using the at least one agent-task pair to generate a trimmed plurality of possible agent-task pairs.

In some embodiments, a cost is computed 202 for each agent-task pair. Computation of the cost is discussed below. In such embodiments, the primary cost function of the first assignment may be based on the cost of a least-optimal agent-task pair in the first assignment. Consequently, the identified at least one agent-task pair may be set to correspond to the agent-task pair associated with the least-optimal cost in the first assignment.

During trimming 208, the agent-task pairs from the plurality of possible agent-task pairs associated with a cost less optimal than or equal to the primary cost function of the first assignment are removed from the plurality of possible agent-task pairs.

Method 200 goes on to generate 209, by the processor 1230, a second assignment of agents to tasks with the primary cost function that is at least as optimal as the primary cost function of the first assignment of agents to tasks.

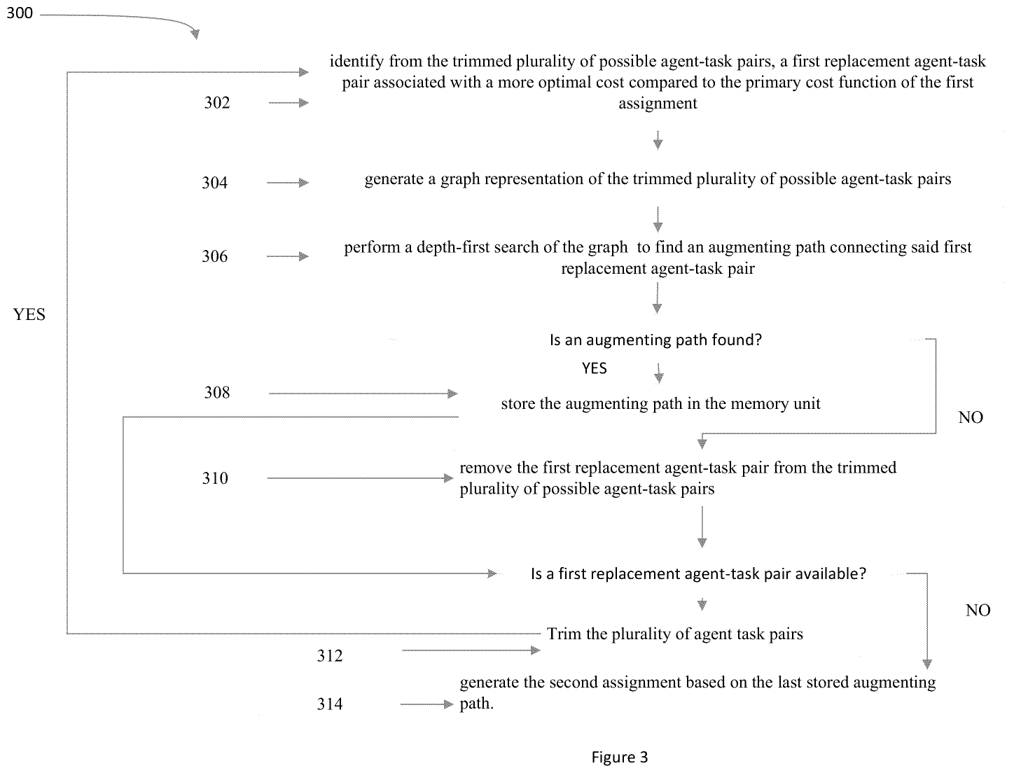

The second assignment is generated 209 by performing a first search on the trimmed plurality of possible agent-task pairs. A more detailed discussion on generation 300 of the second assignment is provided below with respect to FIG. 3.

In a preferred embodiment, the second assignment of agents to tasks is associated with a more optimal primary cost function than the first assignment.

In another preferred embodiment, the second assignment of agents to tasks is associated with the most optimal primary cost function possible.

Once the second assignment, where the primary cost function is optimized, is generated 209, method 200, generates 210 a third assignment. The third assignment of agents to tasks is associated with a secondary cost function that is at least as optimal as a secondary cost function of the second assignment. The primary cost function of the third assignment is at least as optimal as the primary cost function of the second assignment.

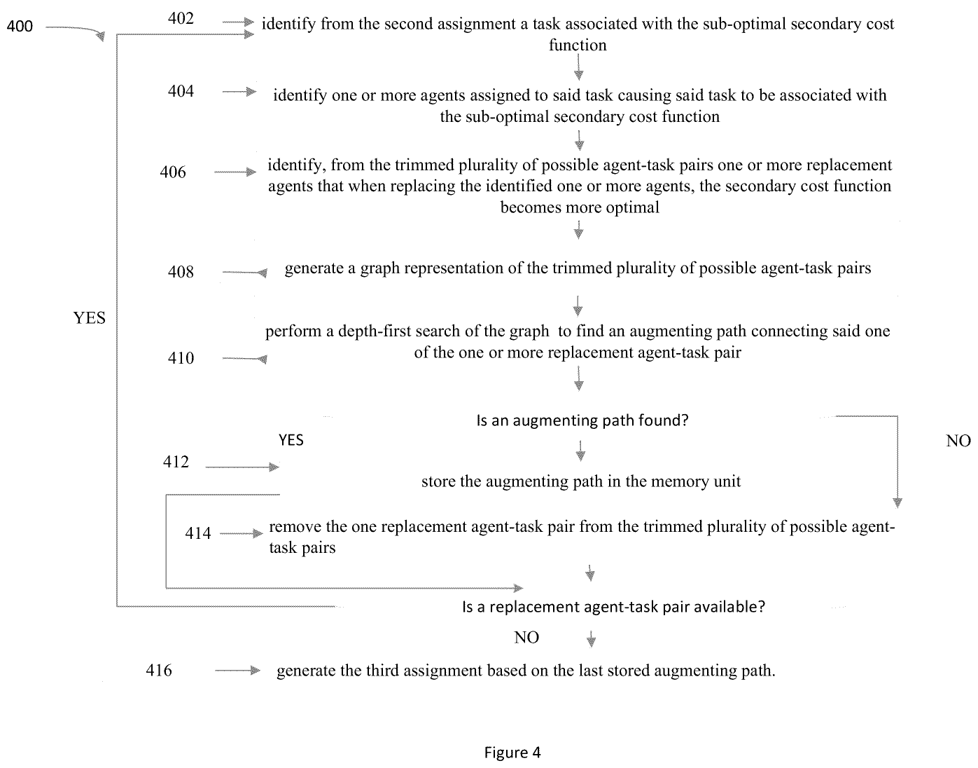

The third assignment is generated 210 by performing a second search on the trimmed plurality of possible agent-task pairs. A more detailed discussion on generation 210 of the third assignment is provided below with respect to FIG. 4.

In a preferred embodiment, the third assignment is associated with a more optimal secondary cost function than the second assignment.

In another preferred embodiment, the third assignment is associated with the most optimal secondary cost function.

In yet another preferred embodiment, the primary cost function of the second assignment is equal to the primary cost function of the third assignment and the third assignment is associated with a more optimal secondary cost function than the second assignment.

In yet another preferred embodiment, the third assignment is Pareto optimal. That is to say, the solution obtained for the secondary cost function is improved such that the secondary cost function becomes minimized while the primary cost function does not lose its optimality in the process of minimizing the secondary cost function.

In embodiments where a cost is computed 202 for each agent-task pair, the secondary cost function represents variation of the cost among agents assigned to each task.

Once the third assignment is generated 210, method 200 goes on to dispatch 212 the plurality of agents to the plurality of tasks based on the third assignment of agents to tasks. At this point, the action unit 1270 may order the agents to perform the tasks according to the third assignment.

The different assignments generated in method 200 may be subject to multiple constraints. Examples of constraints for agents may include that an agent may be dispatched to no more than one task at a time.

In some cases, each task may require to be processed by a specific number of agents. In such cases, an instance of a constraint may be that each task is dispatched with no less than the required specific number of agents for said task. Although, this is desirable, in some cases, the number of agents available is less than the required agents for the tasks. In such cases, an instance of constraint may be that each task is be dispatched with no more than the required specific number of agents for said task.

### Method 300 for Generating the Second Assignment

FIG. 3 shows method 300 for generating the second assignment. According to a preferred embodiment, the second assignment optimizes the primary cost function.

Method 300 may optionally start with identifying 302, from the trimmed plurality of possible agent-task pairs, a first replacement agent-task pair associated with a more optimal cost compared to the primary cost function of the first assignment.

In general, an agent-task pair is to be replaced by a replacement agent-task pair if both pairs have the same task.

Optionally, method 300 may start by generating 304 a graph representation of the trimmed plurality of possible agent-task pairs. FIG. 6 shows such a graph representation.

In all cases, once both identifying 302 and generating 304 are completed, a depth-first search of the graph is performed 306 to find an augmenting path connecting said first replacement agent-task pair.

If said augmenting path is found, it means that the primary cost function has been optimized (that is, the first replacement agent-task pair is associated with a more optimal primary cost function). The method 300 may store 308 the augmenting path in the memory unit 1220.

In order to further optimize the primary cost function, method 300 may go back to identifying 302 from the trimmed plurality of possible agent-task pairs, a first replacement agent-task pair associated with a more optimal cost compared to the optimized primary cost function. The steps of the method 300 may be repeated until no augmenting path is found which means that the optimization of the primary cost function is completed. Each time the steps of method 300 are repeated, the plurality of possible agent-task pairs may be trimmed 312 further to remove all agent-task pairs with a cost greater than or equal to the optimized primary cost function. Once the optimization of the primary cost function is completed, the second assignment is generated 314 based on the last stored augmenting path.

In a preferred embodiment, the first replacement agent-task pair is an agent-task pair from the trimmed plurality of possible agent-task pairs associated with the most optimal cost for the same task. In this case, if the augmenting path is found, cost of said task will be the most optimal possible which would decrease the number of computations needed to optimize the primary cost function. If such a path is not found (that is, it is not possible to find a configuration of agents and tasks that includes the first replacement agent-task pair), the first replacement agent-task pair may be removed 310 from the trimmed plurality of possible agent-task pairs and a new first replacement agent-task pair is to be identified. This process may be repeated until no new first replacement agent-task pair is available (for example, the trimmed plurality of possible agent-task pairs is empty). Ideally, the new first replacement agent-task pair is an agent-task pair from the trimmed plurality of possible agent-task pairs associated with a most optimal cost for the same task after removing 310 of the first replacement agent-task pair from the trimmed plurality of possible agent-task pairs. In this way, once an augmenting path is found, it is the most optimal augmenting path possible.

In some embodiments, an augmenting path is considered to be found when a threshold number of the plurality of tasks is connected to the plurality of agents. This is particularly interesting when the tasks are numerous, the number of agents is insufficient for all tasks, and/or where some tasks have higher priority than the others.

In some instances, all the available first replacement agent-task pairs are tried no augmenting path connecting said first replacement agent-task pair is found. In such instances, the primary cost function cannot be optimized and the first assignment will be used as the second assignment.

FIG. 6 shows a graph representation of the trimmed plurality of possible agent-task pairs. The graph comprises a first plurality of vertices each corresponding to one of the plurality of agents and a second plurality of vertices each corresponding to one of the plurality of tasks. A plurality of edges each connecting a vertex from the first plurality of vertices to a vertex in the second plurality of vertices is also shown. Each edge represents a possible agent-task pair. Each edge is associated with a weight that represents a cost of said agent-task pair. The graph may be a bipartite graph.

### Method 400 for Generating the Third Assignment

FIG. 4 shows method 400 for generating the third assignment. According to a preferred embodiment, the third assignment optimizes the secondary cost function.

Method 400 may optionally start with identifying 402, from the second assignment a task associated with the sub-optimal secondary cost function. Then, one or more agents assigned to said task causing said task to be associated with the sub-optimal secondary cost function are identified 404. Next, one or more replacement agents that when replacing the identified one or more agents, the secondary cost function becomes more optimal are identified 406 from the trimmed plurality of possible agent-task pairs.

As explained before, in general, an agent-task pair is to be replaced by a replacement agent-task pair if both pairs have the same task.

In a preferred embodiment, the task associated with the sub-optimal secondary cost function corresponds to the task associated with the least optimal secondary cost function of the second assignment.

Optionally, method 400 may start by generating 408 a graph representation of the trimmed plurality of possible agent-task pairs.

In all cases, once identifying steps 402, 404, and 406 and generating step 408 are completed, a depth-first search of the graph is performed 410 to find an augmenting path connecting the one of the one or more replacement agents to said task.

If said augmenting path is found, it means that the secondary cost function has been optimized. Method 400 may store 412 the augmenting path in a memory unit 1220.

In order to further optimize the secondary cost function, method 400 may go back to identifying 402, from the second assignment a task associated with the sub-optimal secondary cost function. Steps 404, 406, 408, 410 and 412 may be repeated until no augmenting path is found which means that the optimization of the secondary cost function is completed. Once the optimization of the secondary cost function is completed, the third assignment is generated 416 based on the last stored augmenting path.

In a preferred embodiment, the one of the one or more replacement agent-task pair is such that when replacing the identified one or more agents, the secondary cost function becomes the most optimal possible. In this case, if the augmenting path is found, the secondary cost function will be optimized in view of the identified task (that is, the difference between the highest cost and the lowest cost associated with said task is the most optimal) which would decrease the number of computations needed. If such a path is not found, the one of the one or more replacement agent-task pair may be removed 414 from the trimmed plurality of possible agent-task pairs and a new one of the one or more replacement agent-task pair is to be used in the depth-first search. This process may be repeated until each of the one or more replacement agent-task pair is tried. In this way, once an augmenting path is found, it is the most optimal augmenting path possible.

In a preferred embodiment, the trimmed plurality of possible agent-task pairs used in step 406 is the trimmed plurality of possible agent-task pairs as obtained at step 310. In this way, when a replacement agent-task pair was found impossible while optimizing the primary cost function (that is, it was not possible to find a configuration of agents and tasks that includes the first replacement agent-task pair), the replacement agent-task pair is not tried during optimization of the secondary cost function.

In some embodiments, an augmenting path is found when a threshold number of the plurality of tasks is connected to the plurality of agents. As explained above, this is particularly interesting when the tasks are numerous, the number of agents is insufficient for all tasks, and/or where some tasks have higher priority than the others.

In some instances, all the available replacement agent-task pairs are tried and no augmenting path connecting said replacement agent-task pair is found. In such instances, the secondary cost function cannot be optimized and the second assignment will be used as the third assignment.

### Distributed Implementation

As explained above, the action unit 1270 may be set to generate the exact optimal assignment in real-time through distributed implementation of the method 200 without the need for any centralized processor. That is to say, the processor 1230 performing method 200 may comprise a plurality of processors belonging to the plurality of agents which allows method 200 to be implemented in a distributed manner.

The main difference between centralized and distributed execution of method 200 is that instead of relying upon a centralized processing and memory unit with access to all the sensing information obtained through the sensing unit in the centralized scenario, each agent contributes to the overall implementation process of the agent-task assignment by sharing its local processing power, memory unit, and sensing capabilities with its neighboring agents in the course of distributed implementation. The communication capability established between the agents in the network 1300 allows all agents to share their locally-computed and locally-sensed information with their neighboring agents. The prerequisite components which are properly customized and augmented to the original centralized optimization method in order to fulfill its distributed implementation may be a set of known distributed procedures with various end-goals including: Max-Consensus, Min-Consensus, Average-Consensus, and Update-Consensus procedures. Known distributed computing techniques may be used to combine the computational resources of each of the agents into a single virtual computer.

Alternatively, the processor 1230 performing the method 200 may be the processor of a single agent or of a single remote server that then communicates the results to each of the agents over the network 1300.

### Cost

It is to be understood that, depending on the application, different costs may be of interest. Examples of costs may include temporal duration of processing of a task by an agent (that is, the time it takes the agent to complete the task from the moment the agent is dispatched to the task). The temporal duration of processing of a task by an agent may also be known as the time-to-go.

In the case where the cost is the temporal duration of execution of a task by an agent, the primary cost function may be seen as the highest temporal duration among all assigned agent-task pairs. The secondary cost function may be seen as the highest difference between temporal duration of agents assigned to a same task. Defining the cost in such a manner is particularly interesting in instances where a cluster of agents is required to be allocated to each single task and where the targets represented by tasks could possess maneuvering capabilities. In such instances, the ideal case would be to assign to each task agents whose corresponding costs are the same inside each cluster (that is, the secondary cost function is zero). This ideal case results in the completion of each task (for example, neutralization of each target) by all its assigned agents at the same time. In such an ideal scenario, no time left to alert the target about the incoming cluster of agents which allows the target to initiate its evasive maneuvers before the arrival of the entire cluster of agents. Since this ideal scenario is rarely possible, minimization of the secondary cost function approaches this ideal case as much as possible.

Other costs may be defined depending on the application. Such costs may include:
monetary cost of performing a task j using an agent i;
fuel consumption as cost of performing a task j using an agent i;
electrical power consumption as cost of performing a task j using an agent i;
CPU execution time as computational cost of performing a task j using an agent i (CPU execution time is used to measure processor/memory performance);

the above-mentioned costs could then be customized for a large number of applications.

### Application of the Embodiments to an Example

To better grasp the workings of methods 200, 300, and 400, consider a simple assignment example consisting of four agents and two tasks. Assume for this example that each single task requires at least 2 agents simultaneously for its successful accomplishment, thus establishing 2 as the minimum required size of cluster of agents for each one of the two tasks. Let the cost matrix T associated with four agents and two tasks be evaluated as follows:

$$T = [ \begin{matrix}1.3 & 3.4 \\ 5.7 & 1.6 \\ 4.7 & 7.9 \\ 0.1 & 3.1\end{matrix} ] .$$

In matrix T, the element located in row i and column j may represent the cost of assigning agent i to perform the task j. To demonstrate this assignment problem using a bipartite graph for better visualization, let each agent be represented with a node in the left hand-side whereas each task be shown with a node in the right hand-side. Then, the elements of cost matrix T which represent all possible agent-task pairs may be represented by the edges in the bipartite graph between two nodes corresponding to the considered agent and task. In addition, the cost of each agent-task pair may appear as the weight of its corresponding edge in the graph representation. A bipartite graph representation of the given example is shown in FIG. 6.

At first, the goal may be to assign four agents to two tasks such that the maximum cost value among all four agent-task pairs in the optimal assignment is minimized (this may be rephrased as minimizing the “primary cost function”). After reaching the minimum value of the primary cost function, cluster-range may be defined as the difference between maximum and minimum cost values of the agent-task pairs inside each single cluster. The “secondary cost function” may then be defined as the maximum cluster-range value among all existing clusters (two clusters exist in this example, whose number is equal to the number of tasks). The aim may then be to minimize the secondary cost function while keeping the optimality of the primary cost function unharmed. Note that the sequential manner of optimizing these two cost functions (primary first and secondary afterwards) may result in finding the Pareto optimal solution of the presented dual-objective optimization problem. At the same time, a number of constraints may be set to be satisfied while the dual-objective cost function is minimized including:
1) Every agent may be allowed to be assigned to at most one task at each time instant (each agent could either remain unassigned or to get assigned to maximum one task);
2) In cases where the number of available agents is larger than or equal to the number of agents required to fill in all the clusters according to their given minimum required size, the size of each cluster of agents obtained based on the assignment around each task may be at least equal to the minimum required cluster-size number; and
3) In cases where the number of available agents is less than the number of agents required to fill in all the clusters according to their given minimum required size, at least one task where the size of its corresponding cluster of agents (obtained based on the assignment) may be at least equal to the given minimum required size.

Since the number of available agents (four) is equal to the number of required agents according to the given minimum required size of clusters (two plus two) in this example, we are in the “Agent Surplus” scenario in this example. As a result, each one of the tasks may be matched with exactly two agents, and no agent may remain unassigned at the end.

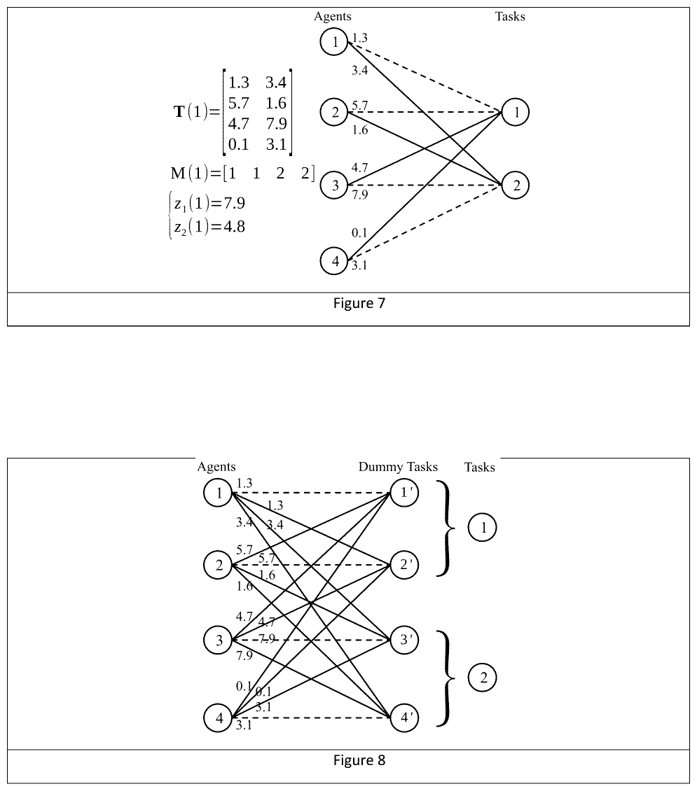

The first step in solving the problem is to generate an initial assignment vector which is shown in FIG. 7 with vector M(1), while satisfying all three aforementioned constraints. Note that vector M(1) may be composed of four elements each one of them may correspond to its associated agent. Moreover, the value of element i of vector M(1) may identify the index of task j that has been assigned to agent i. The first assignment may be obtained by a simple initialization step such as M(1)=[1 1 2 2] for this example. This means that the first and second agents are assigned to the first task while the third and fourth agents are assigned to the second task. The primary and secondary cost functions may be represented by z₁ and z₂, respectively. Using the initial assignment M(1) and cost matrix T, the vector of costs corresponding to four agent-task pairs in M(1) may be obtained as [1.3 5.7 7.9 3.1]. Using their definitions, the primary and secondary cost functions for M(1) may be evaluated as z₁(1)=max(1.3, 5.7, 7.9, 3.1)=7.9 and z₂(1)=max([5.7-1.3], [7.9-3.1])=4.8, respectively. FIG. 7 depicts the first assignment M(1) in a bipartite graph, where the edges of the graph representing the matched agent-task pairs are shown by dashed lines. In addition, the initial cost matrix T(1) is shown as the matrix T in this figure.

Next, the aim may be to minimize the primary cost function (with no regards for the secondary cost function) while satisfying all the constraints at the same time, which may result in generation of the second assignment.

In this example, before entering the main while-loops to start the optimization, a transformation process in which the tasks are replaced with their corresponding dummy tasks may be performed. This may be achieved through replacement of each task with a number of dummy tasks equal to the minimum required size of its corresponding cluster. For this example, task 1 may be replaced with dummy tasks 1′ and 2′ while task 2 may be replaced with dummy tasks 3′ and 4′. After doing that, a modified cost matrix T̅ in which every column j of T is replaced with a number of its copies equal to the minimum required size of its corresponding cluster may be generated. For this example, the first column of T may be replaced with two copies of this column put beside each other, while performing the same step for the second column of T as well. This may result in a modified cost matrix T̅ given as follows:

$$\overline{T} = [ \begin{matrix}1.3 & 1.3 & 3.4 & 3.4 \\ 5.7 & 5.7 & 1.6 & 1.6 \\ 4.7 & 4.7 & 7.9 & 7.9 \\ 0.1 & 0.1 & 3.1 & 3.1\end{matrix} ] .$$

By doing this transformation, the first assignment M(1)=[1 1 2 2] may also be replaced with its modified assignment counterpart M̅(1)=[1′ 2′ 3′ 4′]. The visualization of the modified assignment vector M̅(1) along with modified cost matrix T as well as the newly added nodes of dummy tasks is depicted in FIG. 8. Note that the matched agent-task pairs are depicted by dashed lines.

The first while-loop of the method may now be entered. Based on the modified assignment vector M̅(1), one of the agent-task pairs of the vector M̅(1) with the largest cost value may be identified. This may give the pairing of agent 3 and dummy task 3′ (which corresponds to task 2) whose corresponding cost value is 7.9 (note that 7.9 is larger than all the other three values of 1.3, 5.7, and 3.1). The edge (3,3′) may be trimmed from the Bipartite graph in FIG. 8 along with any other edge whose weight is larger than or equal to 7.9. At the end of trimming, the edges (3,3′) and (3,4′) may be deleted. An augmenting path may be found starting from dummy task 3′ and ending in agent 3. Note that an augmenting path may be formed as an ordered sequence of edges in a graph whose any two consecutive edges in the sequence share a single node between each other, and the ordered edges of this sequence may alternate between an untrimmed edge not belonging to M(1) and an untrimmed edge belonging to the modified assignment M(1). By following this approach, the desired augmenting path may be found using a search procedure built upon the concepts of “depth-first search”. The augmenting path P(1) for this example as an ordered sequence of edges may be obtained as follows:

$$P ( 1 ) = \{ ( {3}^{′} , 2 ) , ( 2 , {2}^{′} ) , ( {2}^{′} , 4 ) , ( 4 , {4}^{′} ) , ( {4}^{′} , 1 ) , ( 1 , {1}^{′} ) , ( {1}^{′} , 3 ) \}$$

FIG. 9 demonstrates the trimmed Bipartite graph along with the augmenting path P(1), depicted by directed dotted lines, while the starting dummy task node 3′ and ending agent node 3 are specified by dashed circles.

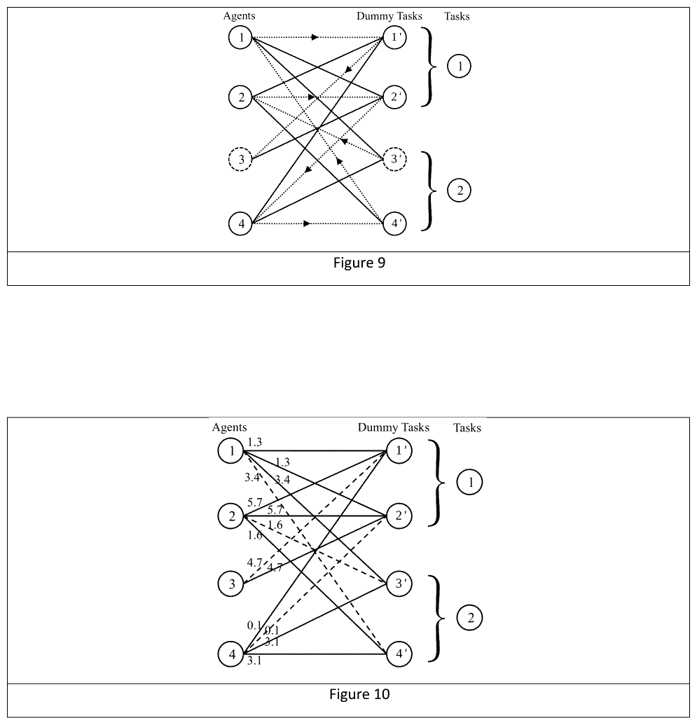

After finding P(1), an updated modified assignment M̅(2) may be obtained using a combination of M̅(1) and P(1). To this end, first notice that agent 3 is assigned to dummy task 1′ according to P(1), thus adding (3,1′) to M̅(2). With reference to FIGS. 8 and 9, P(1) contains the three dashed edges of FIG. 8 including edges (1,1′), (2,2′) and (4,4′). Since these dashed edges represent the assignment according to M̅(1), their assignment may change due to their inclusion in P(1) using those directed dotted edges of P(1) which have corresponding solid edges in FIG. 8. As a result, (1,1′), (2,2′) and (4,4′) may be replaced with (1,4′), (2,3′) and (4,2′), respectively, which may form the updated modified assignment M̅(2)=[4′ 3′ 1′ 2′] with corresponding weight vector [3.4 1.6 4.7 0.1]. The updated modified assignment M̅(2) in the trimmed modified bipartite graph is depicted in FIG. 10 by dashed lines.

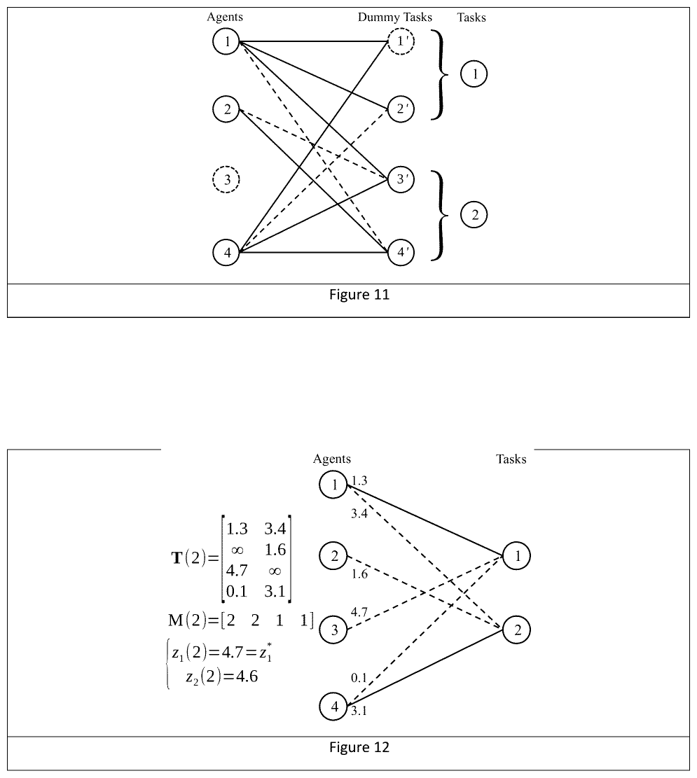

With reference to FIG. 10, another iteration of the first while-loop may be started by identifying (3,1′) as an edge of M̅(2) with maximum cost value of 4.7 out of all four dashed edges. The edge (3,1′) may be trimmed from the bipartite graph of FIG. 10 along with any other edge whose weight is larger than or equal to 4.7, resulting in deletion of (3,2′), (2,1′) and (2,2′). The goal may be to find an augmenting path starting from dummy task 1′ and ending in agent 3. However, such an augmenting path no longer exists due to the node corresponding to agent 3 having no edge connecting to it after performing the latest step of trimming. FIG. 11 depicts the bipartite graph after performing the latest trimming step, where the starting dummy task node 1′ and ending agent node 3 are specified by dashed circles.

Due to the inability to find an augmenting path in FIG. 11, the first while-loop may stop indicating that an optimal assignment for which the primary cost function is minimized has been reached. Note that the latest modified assignment M̅(2)=[4′ 3′ 1′ 2′] may be transformed back to the assignment vector M(2)=[2 2 1 1] with corresponding cost function values of z₁(2)=max(3.4, 1.6, 4.7, 0.1)=4.7 and z₂(2)=max([4.7-0.1], [3.4-1.6])=4.6 along with the trimmed cost matrix T(2), which are all depicted in FIG. 12. Note that z₁*=4.7 denotes the smallest possible value that the primary cost function can reach while satisfying all the aforementioned constraints.

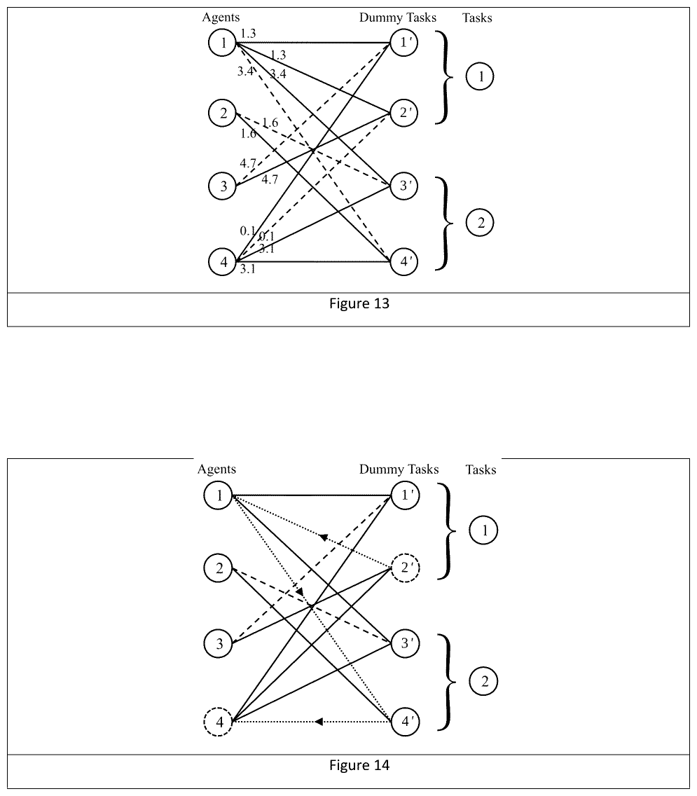

The method may further comprise minimizing the secondary cost function while making sure that the optimality of the primary cost function is maintained. To this end, the second while-loop of the method may be entered while still working in the transformed version of the problem with modified version of the trimmed cost matrix T(2) and modified assignment M̅(2)=[4′ 3′ 1′ 2′]. FIG. 13 depicts the latest transformed version of the trimmed bipartite graph, along with M̅(2) which is specified by dashed lines.

Two cluster-range values associated with the first and second clusters of agents equal to 4.7−0.1=4.6 and 3.4−1.6=1.8, respectively. Since the first cluster has the maximum cluster-range value, the objective may be to reduce its cluster-range value while making sure that the potential increase in cluster-range value of the second cluster does not increase too much. With reference to FIG. 13, the cluster around the first task is composed of two agents 3 and 4 with the corresponding cost values of 4.7 and 0.1, respectively. To ensure that the optimality of the primary cost function is preserved, the pair (3,1′) with the cost value of 4.7 may be kept intact. However, increasing 0.1 as the cost value of the pair (4,2′) may reduce the cluster-range value of the first cluster, resulting in a potential reduction of the secondary cost function. To this end, the assignment of agent 4 to dummy task 2′ may be removed by changing the dashed (4,2′) edge back to a solid edge. The objective may be to find an augmenting path starting from dummy task node 2′ and ending in agent node 4 such that the resultant maximum value of the cluster-range in the updated assignment is smaller compared to the current cluster-range. In other words, augmenting path P(2) may be found which generates an updated third assignment M̅(3) out of M̅(2) such that z₂(3)≤z₂(2) while z₁(3)=z₁(2). By following this method, the augmenting path P(2) may be obtained as:

$$P ( 2 ) = \{ ( {2}^{′} , 1 ) , ( 1 , {4}^{′} ) , ( {4}^{′} , 4 ) \}$$

P(2) is depicted in FIG. 14 using directed dotted edges, while the starting node corresponding to dummy task 2′ and ending node corresponding to agent 4 are depicted by dashed circles.

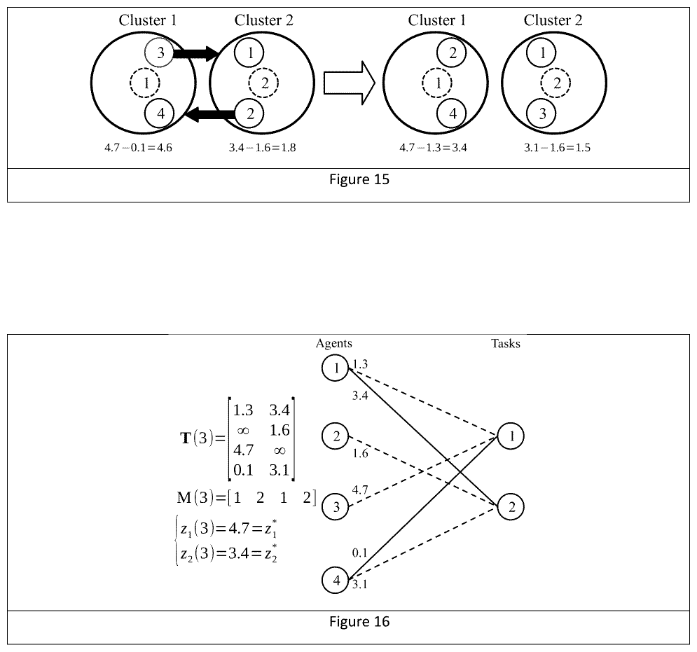

In order to generate the updated modified assignment M̅(3) using the combination of M̅(2) and P(2), a similar method as above may be followed. First, all the dashed edges in FIG. 14 may be kept unchanged inside the new modified assignment M̅(3). As a result, (2,3′) and (3,1′) may be two members of M̅(3). In addition, it follows from P(2) that agent 4 may be assigned to dummy task 4′, making (4,4′) another member of M̅(3). Finally, since P(2) contains one dashed edge of FIG. 13, the assignment of agent 1 may change from dummy task 4′ to dummy task 2′, thus adding (1,2′) to M̅(3). This may result in M̅(3)=[2′ 3′ 1′ 4′] which may be transformed back to the assignment vector M(3)=[1 2 1 2]. Note that the impact of the augmenting path P(2) in minimizing the secondary cost function may be remodeled as a method of finding appropriate sequences of agent swaps between different clusters such that the secondary cost function value is reduced while respecting all the aforementioned constraints of the optimization and maintaining the optimality of primary cost function. For this particular example, impact of P(2) may be described as swap of agents 2 and 3 between first and second clusters, which is depicted in FIG. 15. Note that agents and tasks are depicted by solid and dashed circles, respectively.

The cost vector, corresponding to M(3), is given by [1.3 1.6 4.7 3.1] which results in z₁ (3)=max(1.3, 1.6, 4.7, 3.1)=4.7 and z₂(3)=max([4.7-1.3], [3.1-1.6])=3.4 as the values of the primary and secondary cost functions obtained at this stage of the method for the third assignment. The trimmed cost matrix T(3) is depicted in the form of a bipartite graph in FIG. 16, while the third assignment M(3) is shown by the dashed edges in this figure.

By continuing to the next iteration in the second while-loop of the method, the cluster-range values of task 1 and task 2 are evaluated by 3.4 and 1.5, respectively, resulting in 3.4 as their maximum value. Thus, the goal may be to further reduce the cluster-range value corresponding to task 1. As explained before, 4.7 cannot be manipulated due to optimality preservation of the primary cost function. Thus, a remaining option may be to increase the value of 1.3 in order to reduce the cluster-range value of the first cluster. In the first column of T(3), it may not be possible to do this since 0.1 is smaller than 1.3 while the (2,1) edge of T(3) has already been trimmed. As a result, the value of the secondary cost function may not be reducible, which signifies the termination of the second while-loop. This terminates the method altogether with the Pareto optimal cost function values of (z₁*, z₂*)=(4.7, 3.4), with M(3)=[1 2 1 2] as the final optimal assignment.

### Application of System 1000 as an Anti-Drone System

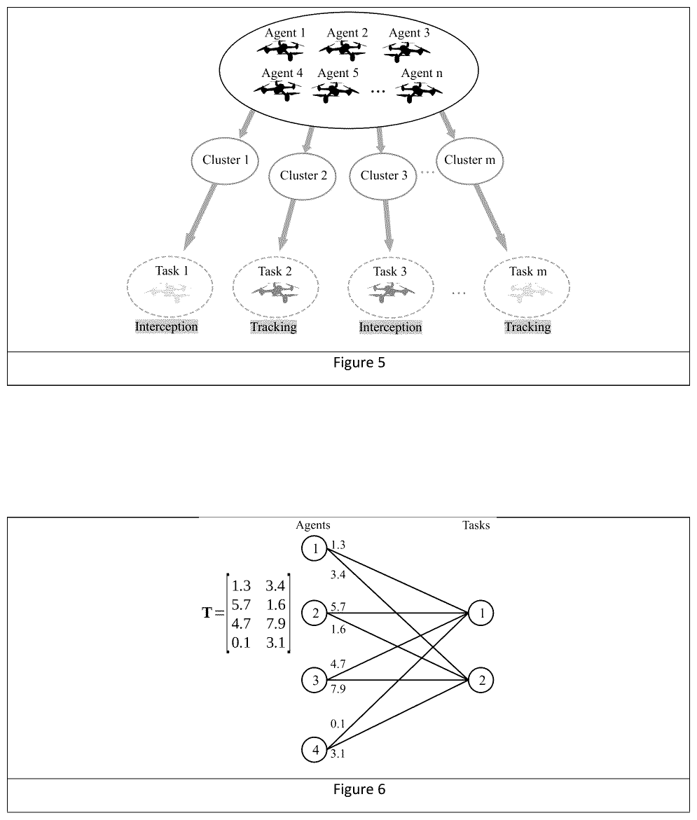

As explained above, an instance of an agent may be a drone and at least one of the plurality of tasks may be to neutralize a drone. FIG. 5 shows a multitude of pursuer drones (shown as Agents 1 to n) available to be deployed for the Anti-Drone System application. Upon identifying a number of tasks in the surrounding environment in the form of either interception or tracking of the detected intruding (evader) drones (shown as Tasks 1 to m), the pursuer drones are optimally assigned to the identified evader drones such that the time required to neutralize the last evader drone is minimized (minimizing the primary cost) while the pursuer drones optimally form clusters assigned to each evader drone such that the maximum amount of time available for the evader drones to perform their evasive maneuvers is minimized as well (minimizing the secondary cost).

Methods 200, 300, and 400 in this case may function as a core element of the Anti-Drone System application comprising a fleet of pursuer drones whose objective is to either intercept and capture intruding drones using their mounted net-guns or to track and scare away the intruding drones from a protected area. For simplicity of notation, all the intruding drones are referred to as “evader drones”.

Depending on the weight, size, and maneuverability of each evader drone, a minimum number of pursuer drones may be required (which may be an integer larger than or equal to one) for successful neutralization of the evader drone. This integer number may determine the minimum required size of the cluster of pursuer drones required for each one of the evader drones. In some cases, once all the required number of pursuer drones reach a certain vicinity of their designated evader drone, they neutralize that evader drone by shooting their net-guns and then they carry away the neutralized drone trapped inside the nets for safe disposal.

Upon having some knowledge on relative position and velocity for each possible pair of pursuer-evader drones (obtained using sensing devices of the Anti-Drone System), the system 1000 is able to compute time-to-go as the least amount of time (starting from the time instant at which measurements are made) required for a pursuer drone to successfully intercept an evader drone. Note that for each pair of pursuer-evader drones, the corresponding time-to-go value may be computed as a positive real number.

In the cost matrix of the discussed Anti-Drone System application, an element located in row i and column j may indicate the time-to-go value associated with the pairing of pursuer drone i and evader drone j. As explained above, this time-to-go value may indicate the least amount of time that it takes for pursuer drone i to successfully intercept the evader drone j (in some cases, this description starts from a time instant at which the sensor readings, used to compute the time-to-go, are measured). The successful interception may be realized for this application when the distance between pursuer drone i and evader drone j becomes less than a pre-specified threshold.

A number of sensor readings and measurements may be required in order to compute the value of time-to-go associated with pursuer drone i and evader drone j including: 1) the relative distance and relative velocity between pursuer drone i and evader drone j, 2) a knowledge of the maneuverability limits of pursuer drone i and evader drone j which may be quantified by the maximum reachable accelerations of these two drones, and 3) a sufficiently small threshold to signify the interception of evader drone j by pursuer drone i once their relative distance becomes less than this threshold.

The objective may be to find the optimal assignment of pursuer drones to evader drones and then send out the fleet of pursuer drones to neutralize the evader drones such that the time required to neutralize the last evader drone is minimized. The primary cost function may be defined as the maximum time-to-go value among all the assigned pursuer-evader pairs.

Evader drones may be intelligent such that they are capable of performing evasive maneuvers upon realizing that some unfriendly drone is chasing them (for example, an evader drone may get alerted when a pursuer drone comes within a certain distance of it). Since each evader drone requires at least a certain number of pursuer drones for its successful neutralization, a cluster of pursuer drones may be assigned to each evader drone such that the time-to-go values of all pursuer-evader pairs inside this cluster have the same value in the best case scenario. This means that all pursuer drones assigned to a particular evader drone may reach the alerting vicinity of the evader drone and fire their net-guns at the same time, leaving no time for the evader drone to perform its evasive maneuvers. However, this ideal scenario is unlikely in reality since it is difficult to have exactly equal values of time-to-go for all pursuer-evader pairs inside each cluster of pursuers assigned to evader drones. As a result, the difference between maximum and minimum values of time-to-go for all pursuer-evader pairs inside each cluster may be defined as the cluster-range value of that cluster whose maximum value among all clusters may be minimized in the optimal solution. Thus, the maximum value of cluster-range among all clusters may be defined as the secondary cost function for a given assignment, which needs to get minimized after successful minimization of the primary cost function. Minimizing the secondary cost function may result in undermining the maneuvering capability of the evader drones in case they possess such abilities.

The method may comprise minimizing a dual-objective cost function, comprising the primary and secondary cost functions, in a pre-determined order: first the assignment vector using a first assignment is initialized, then the second assignment for which the primary cost function is minimized regardless of the secondary cost function may be found, and finally the third assignment for which the secondary cost function is minimized while the primary cost function maintains its optimality may be found. By following this optimization procedure, a Pareto optimal solution may be found. In some instances, a number of constraints may be satisfied at every step of the method. Such constraints may include, for example, one or more of:
every pursuer drone may be allowed to get assigned to at most one evader drone at each time instant,
the size of the cluster of pursuer drones assigned to each evader drone may be at least equal to a minimum required cluster-size. This may be required for the Pursuer Surplus scenario discussed above,
there may exist at least one evader drone whose cluster size (determined based on the assignment vector) is at least equal to the given minimum required size. This may be required for the Pursuer Deficit scenario.

In this case, solving the dual-objective optimization problem may ensure that all evader drones may be intercepted as fast as possible, and at the same time, the evader drones may have a least amount of time available to them in order to exercise their evasive maneuvers (if they have such capabilities). This may result in obtaining the best possible assignment of pursuer drones to evader drones for the Anti-Drone System application.

A person skilled in the art would already appreciate that the teachings of methods 200, 300, and 400 may be used in a scenario where the number of agents and tasks may change arbitrarily over time without any constraining condition on the number of agents and tasks.

### Advantages

Some advantages of the disclosed method and system include providing:
a complex, multi-agent, autonomous system that performs several concurrent tasks in a space that is discovered by the multi-agent system as it moves along; and
concurrent, multi-agent, multi-group management solution in an immersive environment which is dynamically mapped and identified as the agents move;

The proposed method may apply to a wide range of applications where the autonomous agents may take the form of robots, drones, UAVs, UGVs, CPUs, electrical power units, machines. The tasks may be realized as tracking and interception of stationary or mobile physical targets, allocation of memory units, assignment of computational loads, and supplying power grid demands.

A plurality of scenarios for dispatching the agents to their respective tasks may be used examples of which may include an agent surplus scenario and an agent deficit scenario.

Addressing the two scenarios of Agent Surplus and Agent Deficit gives the method the ability to work for a plurality of scenarios no matter how many agents or tasks exist at the beginning of the problem. Agent Surplus scenario occurs when the number of available agents is larger than or equal to the number of agents required to fill in all the clusters according to their given minimum required size. Agent Deficit scenario occurs when the number of available agents is less than the number of agents required to fill in all the clusters according to their given minimum required size. The difference between these two scenarios may be expressed in terms of the constraints of the dual-objective optimization problem. More specifically, different constraints may need to be enforced for Agent Surplus scenario and Agent Deficit scenario.

In the Agent Surplus scenario, there are more agents available than what is required to address all the tasks simultaneously. As a result, two approaches may be followed.

The first approach consists of a conservative approach in which the least number of agents required to address all the tasks simultaneously (this number is determined as a summation of the minimum required size values of all clusters) in an optimal manner while leaving all the excessive number of agents idle and unassigned. This approach is useful for applications where there is a benefit to reducing energy consumption while accomplishing the tasks given that using excessive number of agents automatically induces some unnecessary costs. This scenario may be privileged for the Anti-Drone System application, when evader drones are not smart, and don't have the ability to perform any intelligent evasive maneuvers when they are chased by pursuer drones. In this case, each evader drone is assigned the minimum required number of pursuer drones based on the minimum required cluster size.

The second approach is an overwhelming approach where all the available agents are used and none of them is left idle and unassigned. In consequence, some or all clusters will have more than the minimum required number of agents. Note that this approach is useful for applications where energy consumption is not a concern. Instead, a high priority is put on faster accomplishment of all tasks through overwhelming each task by putting an excessive number of agents in each cluster. This approach can be used for the Anti-Drone System application when evader drones are intelligent, and they have the ability to perform evasive maneuvers. In this case, as the number of pursuer drones beyond the minimum required number of pursuers is increased, the maneuvering capability of the evader drone when it is chased from different directions by a larger number of pursuer drones is reduced.

The Agent Deficit scenario occurs when there is shortage of agents compared to the minimum required number of agents. As a result, not all the clusters of agents are filled for each task with the minimum required cluster size in a single instant of time. Instead, this problem may be solved through gradual accomplishment of the tasks, resulting in gradual reduction in the number of tasks until an Agent Surplus scenario occurs where all the remaining tasks can be simultaneously addressed using the number of available agents. Moreover, satisfaction of the constraint that there should exist at least one evader drone whose cluster size (determined based on the assignment vector) is at least equal to the given minimum required size in agent deficit scenario introduces additional challenges in the method. This constraint may ensure that at least one task receives the minimum required number of agents at any given time instant. This constraint ensures that at least one task has the opportunity to get fully accomplished, which results in a reduction in the number of tasks over time. Thus, this constraint guarantees that the excessive number of tasks compared to the small number of available agents will reduce as time passes, and all the tasks may be accomplished within a finite time interval.

### Computing Unit Implementation

The processor unit 1230 may represent a single processor with one or more processor cores or an array of processors, each comprising one or more processor cores. The memory unit 1220 may comprise various types of memory (different standardized or kinds of Random Access Memory (RAM) units, memory cards, Read-Only Memory (ROM) units, programmable ROM, etc.). The storage unit 1400 may represent one or more logical or physical as well as local or remote hard disk drive (HDD) (or an array thereof). The storage unit 1400 may further represent a local or remote database made accessible to the network node 1300 by a standardized or proprietary interface. The network interface unit 1210 represents at least one physical interface that may be used to communicate with other network nodes. The network interface unit 1210 may be made visible to the other units of the network node 1300 through one or more logical interfaces. The actual stacks of protocols used by the physical network interface(s) and/or logical network interface(s) of the network interface unit 1210 do not affect the teachings herein. The variants of processor unit 1230, memory unit 1220, network interface unit 1210 and storage unit 1400 usable in the context will be readily apparent to persons skilled in the art. Likewise, even though explicit mentions of the memory unit 1220 and/or the processor unit 1230 are not made throughout the description of the present examples, persons skilled in the art will readily recognize that such units are used in conjunction with other units of the network node 1300 to perform routine as well as innovative steps related to the present disclosure.

Various network links may be implicitly or explicitly used in the context shown and described herein. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The teachings herein are not affected by the way the different units exchange information between them. For instance, the memory unit and the processor unit could be connected by a parallel bus, but could also be connected by a serial connection or involve an intermediate unit (not shown) without affecting the teachings herein.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description has been presented for purposes of illustration but is not intended to be exhaustive or limited to the disclosed embodiments. Many modifications and variations will be apparent to those of ordinary skill in the art. The embodiments were chosen to explain the principles of the teachings herein and their practical applications and to enable others of ordinary skill in the art to understand the teachings in order to implement various embodiments with various modifications as might be suited to other contemplated uses.

What is claimed is:

1. A computer-implemented method for dispatching a plurality of agents to a plurality of tasks, the method comprising:
identifying, by a processor, at least one agent-task pair from a plurality of possible agent-task pairs based on a primary cost function of a first assignment of agents to tasks to be used to generate a trimmed plurality of possible agent-task pairs;
generating, by the processor, a second assignment of agents to tasks with the primary cost function that is at least as optimal as the primary cost function of the first assignment of agents to tasks by performing a first search on the trimmed plurality of possible agent-task pairs;
generating, by the processor, a third assignment of agents to tasks with a secondary cost function that is at least as optimal as a secondary cost function of the second assignment of agents to tasks by performing a second search on the trimmed plurality of possible agent-task pairs, such that the primary cost function of the third assignment of agents to tasks is at least as optimal as the primary cost function of the second assignment of agents to tasks; and
dispatching the plurality of agents to the plurality of tasks based on the third assignment of agents to tasks.

2. The method of claim 1, wherein the secondary cost function represents variation of a cost among agents assigned to each task.

3. The method of claim 1, wherein the primary cost function of the first assignment is based on a cost of a least-optimal agent-task pair in the first assignment.

4. The method of claim 1, wherein the trimmed plurality of possible agent-task pairs is generated by removing agent-task pairs from the plurality of possible agent-task pairs associated with a cost less optimal than or equal to the primary cost function of the first assignment.

5. The method of claim 1, wherein generating the second assignment is performed by:
identifying, from the trimmed plurality of possible agent-task pairs, a first replacement agent-task pair associated with a more optimal cost compared to the primary cost function of the first assignment;
generating a graph representation of the plurality of possible agent-task pairs;
performing a depth-first search of the graph to find an augmenting path connecting said first replacement agent-task pair; and
if said augmenting path is found, generating the second assignment based on the augmenting path;
otherwise, using the first assignment as the second assignment.

6. The method of claim 5, wherein the first replacement agent-task pair is an agent-task pair associated with a most optimal cost for the same task.

7. The method of claim 1, wherein the plurality of possible agent-task pairs is represented by a graph, wherein the graph comprises a first plurality of vertices each corresponding to one of the plurality of agents, a second plurality of vertices each corresponding to one of the plurality of tasks, and a plurality of edges each connecting a vertex from the first plurality of vertices to a vertex in the second plurality of vertices, wherein each edge represents a possible agent-task pair, and wherein a weight of each edge represents a cost of said agent-task pair.

8. The method of claim 1, wherein the second assignment optimizes the primary cost function.

9. The method of claim 1, wherein generating the third assignment is performed by:
identifying from the second assignment a task associated with a sub-optimal secondary cost function;
identifying one or more agents assigned to said task causing said task to be associated with the sub-optimal secondary cost function;
identifying, from the trimmed plurality of possible agent-task pairs, one or more replacement agents that when replacing the identified one or more agents, the secondary cost function becomes more optimal;
generating a graph representation of the plurality of possible agent-task pairs;
performing a depth-first search of the graph to find an augmenting path connecting one of the one or more replacement agents to said task; and
if said augmenting path is found, generating the third assignment based on the augmenting path;
otherwise, using the second assignment as the third assignment.

10. The method of claim 9, wherein said task associated with the sub-optimal secondary cost function corresponds to a task associated with a least optimal secondary cost function of the second assignment.

11. The method of claim 1, wherein the third assignment is Pareto optimal.

12. The method of claim 1, wherein each agent is dispatched to no more than one task at a time.

13. The method of claim 1, wherein each task requires to be processed by a specific number of agents and wherein at least one task is dispatched with no more than the required specific number of agents for said task.

14. The method of claim 1, wherein the primary cost function represents a temporal duration of processing of a task by an agent.

15. The method of claim 1, wherein at least one of the plurality of agents is a drone.

16. The method of claim 1, wherein at least one of the plurality of tasks is to neutralize a drone.

17. The method of claim 1, wherein the processor comprises a plurality of processors of the plurality of agents, and wherein the method is implemented in a distributed manner.

18. A non-transitory computer-readable medium comprising computer program code stored thereon for dispatching a plurality of agents to a plurality of tasks, wherein the code, when executed by one or more processors, causes the one or more processors to perform a method comprising:
identifying at least one agent-task pair from a plurality of possible agent-task pairs based on a primary cost function of a first assignment of agents to tasks to be used to generate a trimmed plurality of possible agent-task pairs;
generating a second assignment of agents to tasks with the primary cost function that is at least as optimal as the primary cost function of the first assignment of agents to tasks by performing a first search on the trimmed plurality of possible agent-task pairs;
generating a third assignment of agents to tasks with a secondary cost function that is at least as optimal as the secondary cost function of the second assignment of agents to tasks by performing a second search on the trimmed plurality of possible agent-task pairs, such that the primary cost function of the third assignment of agents to tasks is at least as optimal as the primary cost function of the second assignment of agents to tasks; and
dispatching the plurality of agents to the plurality of tasks based on the third assignment of agents to tasks.

19. A computing device comprising one or more processors operable to perform a method for dispatching a plurality of agents to a plurality of tasks, wherein the method comprises:
identifying at least one agent-task pair from a plurality of possible agent-task pairs based on a primary cost function of a first assignment of agents to tasks to be used to generate a trimmed plurality of possible agent-task pairs;
generating a second assignment of agents to tasks with the primary cost function that is at least as optimal as the primary cost function of the first assignment of agents to tasks by performing a first search on the trimmed plurality of possible agent-task pairs;
generating a third assignment of agents to tasks with a secondary cost function that is at least as optimal as the secondary cost function of the second assignment of agents to tasks by performing a second search on the trimmed plurality of possible agent-task pairs, such that the primary cost function of the third assignment of agents to tasks is at least as optimal as the primary cost function of the second assignment of agents to tasks; and
dispatching the plurality of agents to the plurality of tasks based on the third assignment of agents to tasks.
